(19) United States
(12) Patent Application Publication
(10) Pub. No.: US 2014/0097210 A1
(43) Pub. Date: Apr. 10, 2014

(54) SPOUT WITH CONTROLLED FLUID FLOW FOR PORTABLE FUEL CONTAINERS

(71) Applicant: Nathan Wright, Lexington, KY (US)

(72) Inventor: Nathan Wright, Lexington, KY (US)

(21) Appl. No.: 13/644,754

(22) Filed: Oct. 4, 2012

(51) Int. Cl. B67D 7/06

(52) U.S. Cl. 222/505

(57) ABSTRACT

The present invention provides a spout for use with containers, particularly portable fuel containers (PFCs). The spout generally has a slide assembly physically coupled to a proximally positioned plunger such that the slide and plunger may be manually moved in tandem to variably control the flow rate of liquid or fuel through it. Movement of slide assembly in a distal direction opens the spout, whereas movement in a proximal direction closes the spout. The slide assembly may be in a recessed cavity on the top of the spout. The spout may have a main body portion and a nozzle portion, and a side exit opening at or near the distal end of the spout. Passageways within the spout are designed to encourage segregated and orderly flows of liquid/fuel and air for control and increased flow rate of liquid/fuel from the container. Methods of assembly and operation are also provided.

### BACKGROUND

1. Field of the Invention

The present invention relates to a spout or nozzle for use with a portable fuel container to control fluid flow as well as reduce spills and fuel emissions.

2. Related Art

Portable fuel containers (PFCs) are generally small containers used to transport fuel, such as gasoline, from a retail or industrial site where the fuel is stored, such as a filling station, to another location for remote use. PFCs are typically about 1-6 gallons in volume and are often used for residential or commercial purposes to refuel lawnmowers, vehicles or other equipment.

A challenge with the design and use of PFCs is avoiding or minimizing spilling of fuel and release of volatile organic compounds (VOCs) into the environment. To help reduce these VOC emissions from PFCs, the California Air Resources Board (CARB) has issued rules to reduce these emissions resulting from spills, evaporation and/or permeation through these containers. The EPA has also implemented regulations to control emissions from use of these containers nationwide. All known PFCs on the market today that comply with these standards are ventless containers (with a single opening) and have a spout with an automatic closing/sealing mechanism to help ensure that the spout closes when pouring is ceased.

Despite these efforts, PFCs on the market today are difficult to operate and remain susceptible to fuel spills. The design of PFCs sold today often relies on an “automatic” opening/closing mechanism whereby a valve or plug at the tip of the spout is pushed outward from the nozzle of the spout when the spout is forced against the machine, equipment etc., to be filled, thus creating an opening near the tip between the forcibly separated nozzle and valve. However, because fuel pours out of the opening at a nearly perpendicular angle or straight out the tip of the nozzle with these designs, flow of the fuel out of the spout becomes disordered, which interferes with the vacuum flow of air back into the container. This irregular fuel flow can further result in gurgling or splashing of the fuel, which is difficult to control smoothly and increases the risk of fuel spills and evaporative emissions. Moreover, once the nozzle is removed from the machine, equipment etc., being filled, the automatic closing mechanism does not always snap-back to a closed position quickly enough, which can result in further fuel spilling as the nozzle is removed due to the delayed closure. Current designs also generally lack the ability to control the flow rate of fuel pouring out of the spout in a continuous manner. Due to these shortcomings, some consumers are inclined to modify the existing nozzles after sale to circumvent these controls and improve their performance, which can lead to increased emissions into the environment.

What is needed in the art is an improved spout or nozzle for portable fuel containers, and methods for using the same, which allows for the continuous control of fuel flow rate smoothly out of a portable fuel container and spout. What is also needed in the art is a novel spout or nozzle for portable fuel containers that creates an orderly and smooth outflow of fuel that does not excessively interfere with the flow of air back into the container.

### SUMMARY

According to a first broad aspect of the present invention, a spout is provided comprising: an elongated body surrounding a continuous passageway within the body, the passageway extending from a first opening at the proximal end of the body to an exit opening at or near the distal end of the body, wherein the spout has a top and a bottom; a slide assembly comprising a slide and a plunger, wherein the slide is physically coupled to the plunger such that movement of the slide causes tandem movement of the plunger, wherein the slide is positioned distally to the plunger, wherein the plunger has a base portion and a narrowing portion, the narrowing portion tapering from the base portion to a plunger tip, the base portion of the plunger being wider than the plunger tip, wherein the narrowing portion of the plunger is oriented proximally to the base portion of the plunger, wherein distal movement of the slide causes movement of the base portion of the plunger out of or away from the first opening, and wherein proximal movement of the slide causes movement of the base portion of the plunger into or toward the first opening, and wherein the cross-sectional size and shape of the base portion of the plunger is about the same as the cross-sectional size and shape of the first opening such that the plunger closes the first opening when at least part of the base portion is inserted into the first opening.

According to a second broad aspect of the present invention, a spout is provided comprising: an elongated body surrounding a continuous passageway within the body, the passageway extending from a first opening at the proximal end of the body to an exit opening at or near the distal end of the body, wherein the spout has a top and a bottom; a slide assembly comprising a slide, a stem and a plunger, wherein the slide is physically coupled to the plunger by the stem such that movement of the slide causes tandem movement of the plunger, wherein the proximal end of the stem is connected to the plunger and the distal end of the stem is connected to the slide, and wherein the slide is positioned distally to the plunger; wherein the movement of the slide is generally confined to a proximal-distal axis by a cavity disposed and recessed within the body of the spout, wherein a base portion of the plunger has a cross-sectional size and shape in a plane perpendicular to the proximal-distal axis that is about the same as the cross-sectional size and shape of the first opening, wherein distal movement of the slide causes movement of the base portion of the plunger out of or away from the first opening, and wherein proximal movement of the slide causes movement of the base portion of the plunger into or toward the first opening.

According to a third broad aspect of the present invention, a spout is provided comprising an elongated body surrounding a continuous passageway within the body, the passageway extending from a first opening at the proximal end of the body to an exit opening at or near the distal end of the body, wherein the spout has a top and a bottom; a slide assembly comprising a slide and a plunger, the slide being disposed in a cavity, the cavity being recessed within the body of the spout, wherein the slide is physically coupled to the plunger such that movement of the slide causes tandem movement of the plunger, wherein the slide is positioned distally to the plunger, wherein distal movement of the slide causes movement of the plunger out of or away from the first opening, and wherein proximal movement of the slide causes movement of the plunger into or toward the first opening, wherein the body of the spout comprises a main body portion and a nozzle portion, wherein the nozzle portion is positioned distally to the main body portion and is angled downward relative to the main body portion, and wherein the passageway includes a nozzle lumen inside the nozzle portion of the body, wherein the nozzle lumen has a cone shape with the proximal portion of the nozzle lumen being wider than the distal portion of the nozzle lumen.

According to a fourth broad aspect of the present invention, methods of assembling and/or operating the spout of the present invention are further provided. Operation of the spout may comprise moving the plunger between closed and open positions by manually actuating a slide assembly.

### BRIEF DESCRIPTION OF THE DRAWINGS

FIG. 1A is perspective view of a spout according to an embodiment of the present invention;

FIG. 1B is a longitudinal cross-sectional view of the spout of FIG. 1A;

FIG. 1C is a cross-sectional view of nozzle portion of the spout of FIG. 1A at location indicated by line and arrows 1C in FIG. 1B;

FIG. 1D is a cross-sectional view of main body portion of the spout of FIG. 1A at location indicated by line and arrows 1D in FIG. 1B;

FIG. 2A is a proximal perspective view of a plunger of the present invention;

FIG. 2B is a distal perspective view of the plunger in FIG. 2A;

FIG. 2C is a side view of the plunger in FIG. 2A;

FIG. 3A is a perspective view of a slide assembly of the present invention with the body of the spout removed for visualization;

FIG. 3B is a perspective view of a slide of the present invention;

FIG. 3C is an end view of the slide in FIG. 3B; and

FIG. 3D is a side view of the slide in FIG. 3B.

### DETAILED DESCRIPTION

The present invention relates to a spout or nozzle for use with a portable fuel container (PFC) that is designed to control the flow rate of fuel exiting the spout or nozzle, improve usability and/or to promote smooth and orderly fuel flow. Typically, portable fuel containers have a raised neck portion surrounding an opening in the container with threading on the outside of the neck. A cap with a corresponding interior threading may be further provided that screws down onto the neck to secure a spout to the opening of the container, the cap having a hole in its center to receive the spout through it. In this way, the cap holds the spout in place due to a circumferential lip on the cap that couples with a flange of the spout to press the spout against the neck of the container. The spout of the present invention may be secured in this way to existing PFCs. Even though the spout of the present invention is intended primarily for use with PFCs, the spout could also be used with other liquid containers, which may resemble PFCs. In addition, the spout of the present invention may conceivably be used with larger liquid containers or tanks, which may be stationary, and/or at the end of a hose connected to a liquid container or tank.

According to embodiments of the present invention, a spout is provided having an elongated body with an interior chamber, passageway or lumen disposed or formed therein, such chamber, passageway or lumen being continuous from a first opening at the proximal end of the spout to a second opening or exit opening at the distal end of the spout. Where possible the internal surfaces of the spout are designed to encourage smooth laminar fluid flow in both directions, which together produce a faster and more controllable flow rate. For purposes of the present invention, the term “proximal” refers to a direction toward the portable fuel container, or to an end of the spout nearest the portable fuel container, when the spout is properly connected to the container for use, and the term “distal” refers to a direction away from the portable fuel container, or to an end of the spout furthest away from the portable fuel container, when the spout is properly connected to the container for use. When in use during pouring, fuel exits the container and enters the spout (connected and secured to the container) through the first opening at the proximal end of the spout. The fuel then travels the length of the spout through its interior chamber, etc., and finally pours out through the exit opening at or near the distal end of the spout.

According to embodiments of the present invention, the spout further has a plug or plunger operating to open or close the first opening at the proximal end of the spout. Movement of the plunger from an open to a closed position, or vice versa, may be actuated by a slide assembly comprising a manually operated slide feature physically coupled and linked to the plunger, such that the slide feature and the plunger move in tandem. For example, the slide feature may be linked and coupled to the plunger via an elongated stem such that force applied to the slide feature may be imparted to the plunger. The manually operated slide feature may be designed for operation by hand, finger or thumb to move the slide feature (and thus the plunger) either in a distal direction (to open flow) or in a proximal direction (to close flow). The manually operated slide feature may be disposed in a cavity to constrain movement of the slide to either a proximal or distal direction. Because the slide feature may be operated by hand in both directions, a biasing or spring is not necessary for operation and is generally not preferred. However, a spring could be optionally added to the space between the slide 107 and distal wall 145 in cavity 109 to bias the slide mechanism to a closed position.

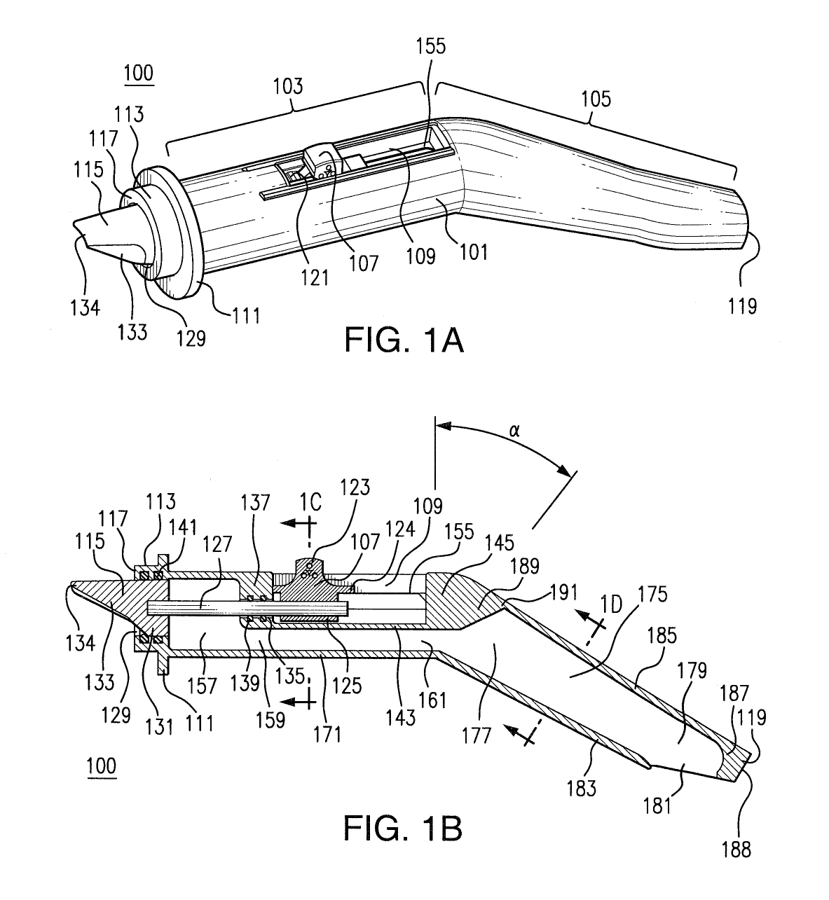

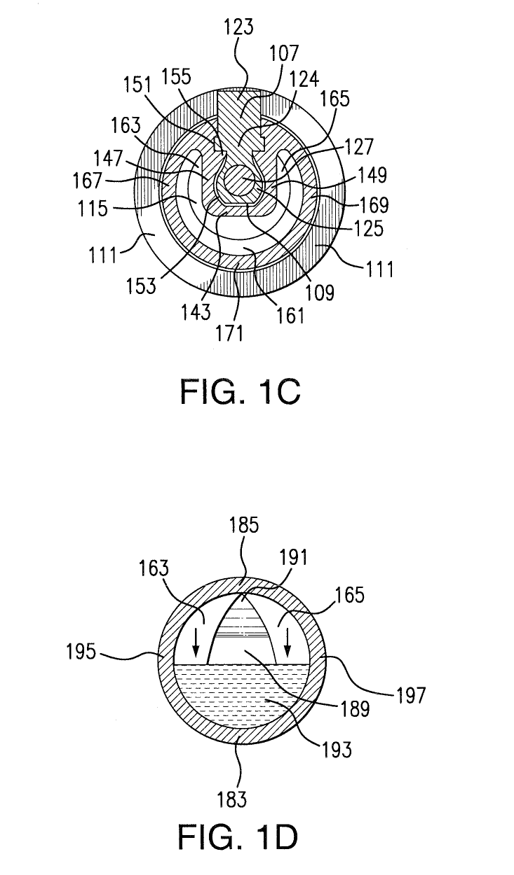

FIG. 1A shows a spout according to an embodiment of the present invention. Spout 100 comprises an elongated body 101 having a chamber, passageway and/or lumen disposed or formed therein for the passage of fluid and air. Body 101 may also be referred to as a casing, housing or frame. Fluid entering the spout 100 from the container first passes through a first opening 129 at the proximal end 117 of spout 100, through the interior chamber, passageway and/or lumen (not shown), and then out through an exit opening (not shown) at or near the distal end 119 of spout 100. The body 101 of the spout 100 may be made of one integrally formed piece, or alternatively, the body 101 may be made of two or more pieces assembled together. Constructing the body 101 of the spout 100 from two or more pieces may facilitate manufacturing and assembly of the spout device.

The body 101 may further comprise a flange 111 near proximal end 117 of spout 100 that meets and rests on top of the neck of a container surrounding the opening of the container (not shown). Flange may be circumferentially formed or comprise spaced-apart portions. The width of the flange 111 in the proximal-distal axis direction may be about 0.1 to about 0.15 inches. As described above, a cap may then be used to secure the spout 100 to the neck of the container. Body 101 of spout 100 may further include an extended portion 113 at proximal end 117 of spout 100 that extends into the neck of the container. Extended portion 113 may be in a range from about zero inches to about 0.4 inches deep in the proximal-distal direction. However, extended portion is an optional feature and may be unnecessary if no O-ring or only one O-ring is used in first opening 129 (see below).

According to some embodiments, the body 101 may comprise a main body portion 103 and a nozzle portion 105 oriented or turned at an angle relative to each other such that the nozzle portion 105 is directed downward at an angle (a) relative to main body portion 103 when the spout 100 is properly connected to a container (see FIG. 1B). The main body portion 103 may be in a range from about 2-5 inches long along its longitudinal axis, and the nozzle portion 105 may be in a range from about 3 inches to about 9 inches long along its longitudinal axis, or preferably about 3 inches to about 5 inches. The downward angle (α) between a plane perpendicular to the longitudinal axis of the main body portion 103 and a plane perpendicular to the longitudinal axis of the nozzle portion 105 may be from 0° to less than 90°, or from about 15° to about 50°, or from about 20° to about 40°, or about 30°. This angle (α) may also be expressed as an angle between the longitudinal axis of the nozzle portion 105 and the longitudinal axis of the main body portion 103 extended distally. The height of spout 100 with an angled nozzle portion 105 as measured vertically (i.e., in a direction perpendicular to the longitudinal axis of the main body portion 103) from the bottom of the distal end 119 of the spout 100 to the top of the main body portion 103 of the spout 100 may be about 2-6 inches depending on the lengths of the main body portion 103 and nozzle portion 105 and the angle between them.

The downward angle may result in a more directed and orderly flow of liquid or fuel through the nozzle portion 105 of the spout 100 having a higher flow velocity (relative to the flow in the main body portion 103) caused by the steeper incline of the nozzle portion 105. This feature may work together with the narrowing of the nozzle portion 105 to create the more directed flow of liquid or fuel through the nozzle portion 105 and exiting the spout 100 as well as an increasing flow velocity through the nozzle portion 105 due to the narrowing of the nozzle lumen 175. By angling the nozzle portion 105 downward relative to the main body portion 103, the nozzle portion 105 may be inserted into the machine, equipment, etc., to be filled without having to lift the portable liquid or fuel container as high. Thus, the main body portion 103 may be kept at a lower angle relative to the ground during pouring resulting in a greater force of gravity acting to keep the flow to the lower portions of the main body portion 103. If the spout were instead more linear along its total length (i.e., without an angled nozzle portion), then the portable container might have to be more inverted during pouring with less gravitational force acting to encourage fluid flow to the lower interior chamber, passageway, etc., in the proximal portion of the spout.

The liquid or fuel being poured and flowing through the spout 100 may also be encouraged to flow along or “hug” the lower portions of the chamber, passageway, etc., within the spout 100 due to gravity and/or surface tension of the liquid or fuel, which favors a more orderly flow of liquid through the spout. Furthermore, confinement of the flow of liquid to the lower portions within the spout 100 also creates room for air to flow back into the container through the upper portions of the chamber, passageway, etc., within the spout 100. The air flowing back into the container will have a natural tendency to flow through the upper portions of the spout interior because it is less dense than the liquid or fuel being poured out. The air pressure of the air flowing through the upper portions of the spout interior will also help to reinforce the flow of the liquid or fuel in the lower portions of the spout interior by exerting a downward force on the liquid or fuel.

According to the embodiment in FIG. 1, the first opening 129 at the proximal end 117 of spout 100 is configured to receive a plunger 115 having a base portion 131 that is sized and shaped to match, correspond to, or be about the same as, the size, dimensions and shape of the first opening 129, such that the sides of the base portion 131 of plunger 115 tightly engage or contact the interior surface of spout 100 around first opening 129, perhaps via interposed O-rings, when the plunger 115 is slid or moved backward to a proximal position to seal or close off the flow of liquid from the container into the spout 100. Indeed, the size, dimensions and shape of the first opening 129 may be slightly greater than the size and shape of the base portion 131 when O-rings are used to accommodate those O-rings.

One of the main advantages and features of the present invention is the ability to variably control the flow rate of liquid or fuel through the spout between a fully closed and a fully open state by operation of a slide assembly that includes a physically coupled plunger. Indeed, movement of plunger 115 in FIG. 1 may be actuated by a manually operated slide 107 physically coupled or linked to the plunger 115. The spout 100 may further have a cavity 109 formed therein, preferably in the top of the body 101 of the spout 100, such as in the top of the main body portion 103 of spout 100. The cavity 109 is designed to hold and restrain the movement of the slide 107 in only a proximal-distal axis. Furthermore, the length of the cavity 109 defines the range of translational movement of the slide 107, and accordingly the range of movement of the physically coupled plunger 115. The cavity 109 will generally have a constant cross-sectional shape and dimensions along its length that matches, or corresponds to, at least a portion of the cross-sectional shape and dimensions of the slide 107 to ensure only linear or translational movement of the slide 107 within the cavity 109 along a single proximal-distal axis while minimizing wobbling of the slide 107. Such proximal-distal axis of movement of the slide 107 may generally be aligned with the longitudinal axis of the main body portion 103 of spout 100. Cavity 109 may also have any suitable and reversible locking mechanism, such as a snap-lock, etc., between a portion of cavity 109 at a proximal location 121 and the slide 107, such that slide 107 and plunger 115 of slide assembly become locked in a closed position when the slide 107 of the slide assembly is moved or slid fully in the proximal direction.

For purposes of the present invention, the terms “top” or “upper” refer to a direction upward, or to a side, wall, face, etc., that is oriented relatively upward or positioned at or toward the top of the spout, when the spout is properly connected to the container, and the terms “bottom” or “lower” refer to a direction downward, or to a side, wall, face, etc., that is oriented relatively downward or positioned at or toward the bottom of the spout, when the spout is properly connected to the container. However, “downward” does not necessarily mean a perfectly downward direction (i.e., a top-to-bottom direction that is perpendicular to the proximal-distal axis of movement of the slide assembly of the spout) and may include any direction that is downwardly angled. Likewise, “upward” does not necessarily mean a perfectly upward direction (i.e., a bottom-to-top direction that is perpendicular to the proximal-distal axis of movement of the slide assembly of the spout) and may include any direction that is upwardly angled. For instance, if the spout has a main body portion and a nozzle portion, then the downward angle of nozzle portion may define a downward direction and bottom of the spout (with the upward direction and top of the spout being directly opposite) even though the downward angle is not perpendicular to the proximal-distal axis of the main body portion.

FIG. 1B shows a cross-sectional side view of the spout 100 from FIG. 1A displaying some of the internal features of the spout. As can be further seen in this figure, slide 107 has an accessible upper portion 123 for application of a manual force, such as by pushing or pulling with one's finger or thumb, to actuate movement of the slide 107 forward (distally) or backward (proximally). The side faces of the upper portion 123 of slide 107 may have one or more divots and/or the top face of the upper portion 123 may have a series of grooves or the like (not shown) to improve gripping. The slide 107 also has a lower portion 125 grasping or connected to a stem, rod or bar 127 at or near the distal end of the stem 127. The upper portion 123 may be linked to the lower portion 125 by a middle portion 124. The opposite proximal end of stem 127 is connected to plunger 115 by insertion into a hole formed in the distal surface of base portion 131 of plunger 115 facing the interior of the spout 100. To secure the stem 127 to lower portion 125 of slide 107 and to the base portion 131 of plunger 115 so that these pieces move together under force without slipping, any additional securing means may be used, such as adhesives, flanges, snap engagements, etc., perhaps in addition to there being a tight or forced fit between them. As an alternative, the stem 127 may be formed integrally with the plunger 115 as one piece, the stem 127 may be formed integrally with the slide 107 as one piece, or the stem 127 may be formed integrally with the plunger 115 and the slide 107 as one piece. Manufacturing of such integral pieces may be by one process, such as injection molding, etc.

The cavity 109 formed in top of spout 100 may be recessed within the spout 100, and the top of the cavity 109 may be open to the outside environment. The cavity 109 may be generally separated from the interior chamber, passageway, etc., within the spout 100 by a plurality of cavity walls. However, a single bore 135 may be present through a proximal wall 137 of the cavity 109 to allow stem 127 to pass through it and reach plunger 115. The cross-sectional size and shape of bore 135 will generally be about the same as that for at least the portion of the stem 127 that slides through bore 135 by translational movement of slide 107, such that the stem 127 has a close-fit or seal with the interior surface of bore 135 over its range of motion, perhaps via one or more interposed O-rings 139. Although two O-rings 139 are shown, one O-ring may be sufficient. Such O-ring(s) may be any of a variety of O-rings available, including Quattro O-rings or seals, and may generally be made of a petroleum-resistant material for use with PFCs. Quattro seals have a clover-leaf cross section that creates multiple contacts with the opposing surfaces to improve the seal and resist rolling. These superior features may allow only one, as opposed to two, O-ring(s) to be used. The close-fit or seal between bore 135 and stem 127 ensures that liquid or fuel passing or flowing through the interior of spout 100 does not leak or seep into cavity 109 and into the outside environment. In addition to proximal wall 137, the cavity 109 is further separated from the interior of spout 100 by bottom wall 143, distal wall 145, first side wall 147 and second side wall 149 (see also FIG. 1C).

As mentioned above, a slide 107 comprising an upper portion 123 and a lower portion 125 may further comprise a middle portion 124. According to the embodiment in FIG. 1, as more clearly shown in FIG. 1C, middle portion 124 and lower portion 125 of slide 107 may be positioned within upper slot 151 and/or lower slot 153 of cavity 109, respectively. Upper slot 151 and/or lower slot 153 of cavity 109 may have a cross-sectional size, dimensions and shape to match, or correspond to, the cross-sectional size, dimensions and shape of the middle portion 124 and lower portion 125 of slide 107 such that movement of the slide 107 is constrained to a proximal-distal axis by the slot(s) of the cavity 109. An upper side wall(s) of the cavity 109 even with the outer sides of the spout body 101 may also contact the side face(s) of the upper portion 123 of slide 107 to constrain movement and define the upper slot 151 of cavity 109. In addition, part of the lower portion 125 of the slide 107 connected to middle portion 124 may be narrower than the middle portion 124 such that middle portion 124 may rest on a ledge 155 projecting from the first side wall 147 and second wall 149 of cavity 109. Ledge 155 may also project into cavity 109 from proximal wall 137 and distal wall 145 such that ledge 155 is continuous in a plane around the periphery of cavity 109. Ledge 155 may operate to confine movement and avoid wobbling of slide 107 by contact with a lower surface of middle portion 124 of slide 107 even without a defined upper slot 151 of cavity 109.

As also mentioned above, the slide assembly and slide 107 will generally be positioned at the top of the body 101 and/or the main body portion 103 of spout 100. This position has the advantages of being accessible, more easily operated by hand, and further helping to properly align and orient the placement of the spout into the opening of the container. Placement of the slide assembly at the top of the spout may also orient the cavity 109 and a U-shaped central passage 159 (see below) to help dispose the liquid or fuel flow to the lower portion of the central passage 159 with the air having less density passing through the more obstructed upper portion of the central passage 159. However, it is conceivable that the slide assembly could be located at other positions around the periphery of the sides of the spout body without departing from the same or similar manner of operation of the slide assembly as described herein. Moreover, the exact type, construction, shape, etc., of the slide may vary while preserving the same basic principles and manner of operation. For example, even with the cavity shown in FIG. 1, the slide, and particularly the upper portion of slide actuated directly by hand, could have a variety of different sizes and shapes. For example, it is conceivable that a larger slide feature, such as a sleeve, handle, etc., could even be used for operation by hand, with such translational forces then transferred to a stem and plunger in much the same manner.

As shown in FIG. 1A and more clearly in FIG. 1B, base portion 131 of plunger 115 is closely or snugly fit within first opening 129 at the proximal end 117 of spout 100. O-rings 141 may be interposed between inner surface of spout 100 around first opening 129 and base portion 131 of plunger 115. Although two O-rings 141 are shown, one O-ring may be sufficient. Such O-ring(s) may be any of a variety of O-rings available, including Quattro seals, which may generally be made of a petroleum-resistant material for use with PFCs. Quattro seals have a clover-leaf cross section that creates multiple contacts with the opposing surfaces to improve the seal and resist rolling. These superior features may allow only one O-ring to be used.

Plunger 115 will generally have a size and shape that tapers from its widest dimensions at its base portion 131 (corresponding in size and shape to the cross-section of first opening 129) along narrowing portion 133 to a plunger tip 134 with the tapering of the narrowing portion 133 being strongly favored and oriented to one side of plunger 115 such that narrowing portion 133 and plunger tip 134 will be closer to one side of spout 100 when assembled with spout 100. In general, plunger 115 will be oriented in spout 100 when attached to stem 127 of slide assembly and inserted into first opening 129 such that narrowing portion 133 and plunger tip 134 of plunger 115 is closest to the top of spout 100.

FIG. 1B shows slide 107, stem 127 and plunger 115 positioned in a most rearward or proximal position to place plunger 115 in a closed position due to at least part of the base portion 131 of plunger 115 being fully inserted into and filling the entire first opening 129 of spout. However, when slide assembly including slide 107 and stem 127 are moved distally, base portion 131 of plunger 115 is moved gradually out of first opening 129 of spout 100 to create a gap between narrowing portion 133 of plunger 115 and the inner surface within first opening 129 of spout 100. Liquid or fuel is then allowed to flow out of the container and into spout 100 through such gap in first opening 129. When the slide assembly is moved distally from its closed position, the gap is first formed in the bottom-most portion of the first opening 129 due to the tapered shape of plunger 115 and its orientation and placement with the narrowing portion 133 and plunger tip 134 of plunger 115 toward or closer to the top of spout 100. As the slide assembly and plunger 115 are moved further in a distal direction, the gap becomes increasingly widened within bottom portion of first opening 129. Thus, due to the tapered shape of the plunger 115, flow of liquid or fuel into the spout 100 from the container may be regulated and controlled continuously and gradually at will by moving the slide assembly (and thus the plunger 115) from a closed proximal position toward an open distal position, or vice versa.

The following is a general description of the flow of liquid or fuel through the spout embodiment of FIG. 1. When the fluid or fuel flows into the spout 100 from the container, it first enters a proximal chamber 157 located between the distal surface of base portion 131 of plunger 115 and the proximal wall 137 of spout 100. The proximal chamber 157 may have a diameter of about 1.5 inches or less, or alternatively about 1 inch or less, and the first opening 129 may have a smaller diameter of less than 1.5 inches, or about 1 inch or less, or from about 0.7 to about 0.8 inches. The liquid or fuel then continues to flow through a U-shaped central passage 159 corresponding to the length of the cavity 109 and presence of walls 137, 143, 145, 147, 149 surrounding cavity 109. Both the proximal chamber 157 and central passage 159 may be located in main body portion 103 of spout 100. The outer sides around U-shaped central passage 159 may have a radius of curvature of about 1.5 inches or less, or about 1 inch or less.

As more clearly seen in FIG. 1C, central passage 159 may comprise a lower channel 161, a first side channel 163 and a second side channel 165. The lower channel 161 of central passage 159 may be generally the volume between the bottom outer side 171 of spout 100 and bottom wall 143 of cavity 109 and slide assembly. The first side channel 163 may be generally the volume between first outer side 167 of spout 100 and first side wall 147 of cavity 109, and second side channel 165 may be generally the volume between second outer side 169 on outside of spout 100 and second side wall 149 of cavity 109. Even though lower channel 161, first side channel 163 and second side channel 165 of FIG. 1 are described separately, these channels may not have specific boundaries between them but instead may refer to regions of the continuous U-shaped central passage 159. Likewise, bottom outer side 171, first outer side 167 and second outer side 169 of spout 100 in FIG. 1 may not have specific boundaries between them but may refer to regions of the continuous outer sides of the spout.

After the liquid or fuel pours or flows through the central passage 159, it then enters a nozzle lumen 175 in the nozzle portion 105 of spout 100 from a proximal portion 177 to a distal portion 179 of nozzle lumen 175 and finally flows out of spout 100 through an exit opening 181 at or near distal end 119 of spout 100.

Several factors contribute to the liquid or fuel flowing through spout 100 to remain in, and be confined to, mostly the lower portions of the proximal chamber 157, central passage 161 and nozzle lumen 175. As explained above, when plunger 115 is moved distally from a closed position, liquid or fuel entering spout 100 from container passes through a gap at the bottom-most portion of first opening 129 due to plunger 115 being tapered to one side with narrowing portion 133 and plunger tip 134 oriented and positioned closer to the top of the spout 100. In addition, the taper of the plunger 115 helps to direct or divert the liquid or fuel flow downward to the lower portion of first opening 129 as it approaches first opening 129 of spout 100 from inside the container. Therefore, the liquid or fuel first enters proximal chamber 157 of spout 100 in the lower portion of the proximal chamber 157. Furthermore, as long as each portion of the spout 100 is not fully inverted, gravity will operate to cause, or at least dispose, the liquid or fuel to flow along the lower portions of proximal chamber 157, central passage 159 and nozzle lumen 175. Due to surface tension, fluids may also have a tendency to cling to surfaces, such as the bottom surfaces of the proximal chamber 157, central passage 159 and nozzle lumen 175. As mentioned above, the downward angle of the nozzle portion 105 of spout 100 will allow the user to pour the liquid or fuel with less inversion of the main body portion 103 of spout 100. Moreover, the walls 137, 143, 145, 147, 149 surrounding the cavity 109 and slide assembly and hanging down from the top of the spout 100 may also promote, dispose and/or divert the fuel or liquid to flow along the less impeded lower channel 161 of central passage 159. The side exit opening 181 may also assist the smooth outflow of liquid or fuel from the lower portion of the nozzle lumen 175 (see below).

With the liquid or fuel preferentially flowing in, or at least mostly confined to, the lower portions of proximal chamber 157, central passage 159 and nozzle lumen 175, air flowing back into the container may be better able to flow through the upper portions of spout 100. The air flowing back into the container will naturally want to flow through the upper portions of the spout because it is less dense than the liquid or fuel. This flow of air through the upper portions may also help to reinforce the flow of liquid or fuel to the lower portions of proximal chamber 157, central passage 159 and nozzle lumen 175 due to force exerted by air pressure. The upper surface of the liquid or fuel in the lower portions of the spout interior may also act as a barrier or “skin” that dynamically resists being broken or disturbed by the air flowing in the upper portions due to any surface tension of the liquid or fuel.

According to embodiments of the present invention, an exit opening may be further located at the distal end of the spout to allow the liquid or fuel to exit the spout (and also for air to enter the spout). As can be seen in FIG. 1B, an exit opening 181 may be formed in a bottom-distal location or corner of the nozzle portion 105 as if the bottom-distal location of the nozzle portion 105 were “cut-away” to create the exit opening 181. Such a side exit opening 181 may span from a location on the bottom side 183 of nozzle portion 105 to a location on the distal end 119 or outer distal face 188 of spout 100.

The proportions of the exit opening 181 may be about 1 inch×1 inch or less, and the proximal-distal dimension may be a little greater than the width dimension. Furthermore, the width of the exit opening 181 near its proximal end may be less than the width of the exit opening 181 near its distal end, such that the exit opening has a trapezoidal-like shape. Due to the narrower width at the proximal end of the exit opening 181, a greater proportion of the total proximal-distal length of the exit opening 181 is needed for the same cross-sectional area near the proximal side of the exit opening 181 than near the distal side of the exit opening 181. Accordingly, the air flowing into the nozzle portion 105 may be more confined to a smaller length of the exit opening 181 near its distal end, thus reserving more of the length of the exit opening 181 near its proximal end for the exiting of the liquid or fuel. This feature can promote the smooth flow of liquid or fuel out of the spout since the cross-sectional shape of the liquid or fuel flow in nozzle lumen 175 may be less altered at the exit opening 181 by the inflowing air.

The outer defining edges of the exit opening 181 in a bottom-distal location of the nozzle portion 105 may be present in a plane. Such plane of the exit opening 181 may be slanted from a location on the bottom side 183 of nozzle portion 105 to the distal end 119 of spout 100 at a non-perpendicular angle relative to both the distal end 119 of the spout 100 and the bottom side 183 of the nozzle portion 105. For example, the angle between such plane of the exit opening 181 and the top side 185 of nozzle portion 105 may be greater than 0° but less than 90°, or more preferably from about 10° to about 40°, or from about 15° to about 25°, or about 20°. Distal end 119 of the nozzle portion 105 may further have a flat outer face 188 in a plane nearly or perfectly perpendicular to the longitudinal axis of the nozzle portion 105. In such a case, the plane of the exit opening 181 may be slanted at a non-perpendicular angle relative to the outer face 188.

Even if the edges of exit opening 181 are not perfectly planar, exit opening 181 may still be defined as having the same general orientation such that a line from a location or position on the bottom side 183 of nozzle portion 105 along an edge of exit opening 181 to another location or position on the outer face 188 along an edge of exit opening 181 is similarly slanted at a non-perpendicular angle relative to bottom side 183 and outer face 188.

It is also worth noting that at least a segment of the distal portion 179 of nozzle portion 175 may be angled upward very slightly relative to the longitudinal axis of the proximal portion 177 of nozzle portion 175. In such a case, the plane of distal outer face 188 may be described as nearly or perfectly perpendicular to the longitudinal axis of either the proximal portion 177 or the slightly angled distal segment of nozzle portion 105.

To improve flow of the liquid or fuel out of the nozzle portion 105 of the spout 100, an interior surface 187 at the distal end 119 of the nozzle lumen 175 may also be contoured or rounded in one or more dimensions to more gently direct or divert the direction of liquid or fuel flow in the lower portion of nozzle lumen 175 out the slanted side exit opening 181. Such a slanted side exit opening 181 has an increased outflow area compared to a hypothetical straight opening at the distal end of the nozzle portion (i.e., an opening spanning from the top side 185 to the bottom side 183 of the nozzle portion 105). The increased outflow area of the slanted side exit opening 181 of the present nozzle design further increases flow rate of the liquid or fuel exiting the nozzle portion 105, which may produce a smoother and more controlled flow of liquid or fuel out of the spout 100. The side exit opening 181 also avoids the liquid or fuel from “shooting” out the distal end. However, while a side exit opening may be preferred, it is envisioned that a straight exit opening at the distal end of the spout (i.e., an opening spanning from the top side to the bottom side of the nozzle portion) may conceivably be used in combination with other inventive features.

Due to vacuum pressure created inside the container and spout as a result of the liquid or fuel being poured out of the container and spout, air is pulled or sucked back into the spout and container to replace the volume of liquid or fuel being poured. This design of the slanted side exit opening 181 in combination with other features improves the flow of air through the exit opening 181 into the nozzle lumen 175 by encouraging the air entering the spout 100 to quickly flow straight up to the top of the nozzle lumen 175. By driving the inward flowing air immediately upward, the air may become more quickly segregated from the outflowing liquid or fuel. The contoured or rounded interior surface 187 at the distal end of nozzle lumen 175 may also help to smoothly guide the air into the upper portion of the nozzle lumen 175 without sharp transitions. The exact shape and dimensions of the contoured or rounded interior surface 187 may vary. Once the air flow arrives in the upper portion of the nozzle lumen 175 and continues to flow proximally along the upper portions of the spout interior, interference or interruption of the outflow of liquid or fuel in the lower portions of the spout interior by the air may be minimized, which may translate into a faster flow rate of the liquid or fuel out of the spout.

Once the air entering the exit opening 181 reaches the upper portion of the nozzle lumen 175, the air continues to flow in a proximal or rearward direction along the upper portion of the nozzle lumen 175. In its path toward the container, the air flow encounters the slide assembly, which forces a bifurcation of most or all of the air flow around each side of the slide assembly. As shown in FIGS. 1B and 1D, a tapered structure 189, which may have a cone-like or pyramid-like shape, is present on the distal side of distal wall 145 of cavity 109 that is blended or fused with the top side 185 of nozzle portion 105. This tapered structure 189 from point 191 helps the air flow glide past the slide assembly and makes the bifurcation of the air flow more orderly and smooth. The tapered structure 189 comes to a narrow-most point 191 at its distal end where it meets the top side 185 within nozzle lumen 175. The tapered structure 189 gradually tapers from the point 191 to the cross-sectional shape of distal wall 145 of cavity 109 to encourage or dispose the air flowing proximally to undergo a smooth and orderly transition from the combined air flow in the nozzle lumen 175 to the at least partially bifurcated air flow on each side of the slide assembly through first channel 163 and second channel 165 of central passage 159. However, although the tapered structure 189 may generally be a preferred feature, this tapered structure 189 may be absent (e.g., surface of distal wall facing nozzle lumen may be approximately flat) according to some embodiments when present in combination with other inventive features. The liquid or fuel 193 flowing outward is also depicted in the lower part of the nozzle lumen 175 in FIG. 1D. After the bifurcated air flow passes the slide assembly, it becomes recombined in the upper portion of proximal chamber 157 before flowing into the container through the first opening 129.

To further improve the fluid flows in both directions, the nozzle portion 105 and/or nozzle lumen 175 may be tapered in a cone shape such that the diameter or width of the proximal portion 177 of nozzle lumen 175 is greater than that of the distal portion 179 of nozzle lumen 175. To form a cone shape, the top side 185 and bottom side 183 of nozzle portion 105 as well as the two sides of nozzle portion 105 are angled toward each other in the distal direction. As such, the diameter or width of the nozzle lumen 175 near its proximal end is greater than the diameter or width of the nozzle lumen 175 near its distal end. This may be defined by the following equation, D_{big}≧Dₛₘₐₗₗ≧0.1*D_{big}, in which D_{big} is the diameter of proximal-most portion of the nozzle lumen 175 (which may be about the same as the diameter of the proximal chamber 157 and/or central passage 159) and Dₛₘₐₗₗ is the diameter of the nozzle lumen 175 at or near the proximal side of the exit opening 181. This widening toward the proximal portion 177 facilitates or encourages a continuous and smooth division or bifurcation of the air flow around the tapered structure 189 and slide assembly by minimizing constriction and giving room for the air flow to spread, such that the air flow does not impinge or create a higher pressure zone where the liquid or fuel 193 is flowing out into the nozzle lumen 175. By maintaining a continuous and smooth air flow, a faster flow rate of the liquid or fuel 193 may be achieved.

Eventually, vacuum pressure created by the liquid or fuel flowing out of the container and nozzle may also operate to provide an automatic shut-off mechanism. Shortly after the level of liquid or fuel in the machine, equipment, container, etc., being filled rises to a level where the exit opening 181 becomes immersed within the liquid or fuel, flow of the liquid or fuel out of the container and spout 100 ceases due to the vacuum pressure and the inability of air to flow into the exit opening 181 and spout 100. When this happens, the user may simply move the slide 107 and plunger 115 to the closed position and remove the spout 100 without spilling.

While a round or circular cross sectional shape may generally be preferred as shown in FIG. 1, the outer sides of the body of a spout of the present invention, including the main body portion and/or the nozzle portion of the spout, may have different cross-sectional shapes, such as an oval or diamond shape, without departing from the spirit and scope of the present invention. If different shapes are used, then the cross-sectional shape(s) of the other features of the present invention may also be different to accommodate such alteration. Generally, however, it may be preferred that the cross-sectional shape of the proximal chamber 157, central passage 159 and nozzle lumen 175 have a side-to-side width near the bottom or lowermost portion that is narrower than the width above it. This has the advantage of encouraging a more orderly and smooth liquid or fuel flow in response to any pressure variations caused by irregular air flow or bubbles. For example, as depicted in FIG. 1D for the nozzle lumen 175, any downward pressure (indicated by arrows) exerted by the air above the liquid or fuel 193 will be resisted by the narrowing of the width between the sides of the nozzle lumen 175 toward its lowermost portion or bottom. This reduces irregular flow of the liquid or fuel 193 caused by fluctuations in air pressure or by the presence of small air bubbles. As mentioned above, the surface tension of the fluid may also resist interruption of its upper surface.

Another advantage of the spout of the present invention according to those embodiments having a nozzle portion with outer sides that taper toward the distal end of the spout is that the nozzle portion may be inserted into an opening of the machine, equipment, etc., to be filled until the nozzle portion forms a close-fit with such opening to help reduce evaporative emissions from such opening of the machine, equipment, etc., being filled. Such close-fit of the spout may also help to partially stabilize or support the inverted container connected to the spout during pouring.

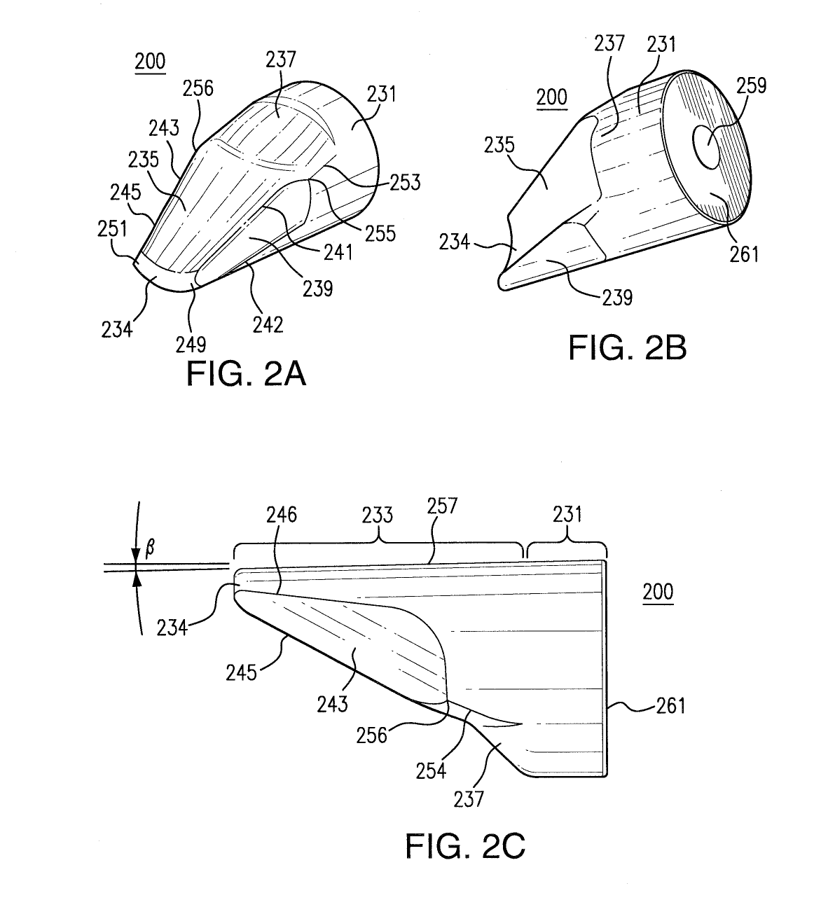

According to some embodiments, FIG. 2 shows several views of a plunger 200 of the present invention corresponding to plunger 115 in FIG. 1. As mentioned above, plunger 200 may have a base portion 231 and a narrowing portion 233 tapering down to a plunger tip or tongue 234. Plunger tip 234 may be described as being on the proximal end of the plunger 200, and base portion 231 may be described as being on the distal end of the plunger 200. As can be seen in these figures, plunger 200 may have multiple surfaces that work to encourage or dispose laminar flow and diversion of liquid or fuel form the container into the lower portion of proximal chamber of spout. Plunger tip 234 may have an inwardly curved surface from a first end 249 to a second end 251 to bring or gather liquid or fuel flow over bottom surface 235. However, in the direction from the plunger tip 234 to the base portion 231 of plunger 200, the inwardly curved plunger tip 234 and bottom surface 235 transitions to and includes an outwardly curved surface 237 near base portion 231, base portion 231 also being outwardly curved. As explained above, the base portion 231 is outwardly curved to match or correspond to the cross-sectional size and shape of the proximal first opening of the spout. In the proximal-distal axis, base portion 231 may have a length from about 0.25 to about 0.3 inches, narrowing portion 233 may have a length from about 0.75 to about 1.2 inches, and outwardly curved surface 237 may be from about 0.2 to about 0.4 inches long. The total length of the plunger 200 may be from about 1 inch to about 1.5 inches. However, the exact dimensions may vary and may depend on the positioning of the slide assembly and the length of the stem.

Bottom surface 235 of plunger 200 may also be at least partially separated from top surface 257 by a first side face 239 and a second side face 243. First side face 239 may be defined by a first bottom edge 241 next to a bottom surface 235 and a first top edge 242 next to top surface 257, and second side face 243 may be defined by a second bottom edge 245 next to a bottom surface 235 and a second top edge 246 next to top surface 257. First side face 239 may extend from first end 249 of plunger tip 234 to a first tri-point 255 where first top edge 242 and first bottom edge 241 meet. Likewise, second side face 243 may extend from second end 251 of plunger tip 234 to a second tri-point 256 where second top edge 246 and second bottom edge 245 meet. First side edge 239 and second side edge 243 may also converge toward each other toward the tip 234, such that the width of the tapering portion 233 is less near tip 234 than nearer to base portion 231.

In addition, a first middle edge 253 of plunger 200 may be positioned from first tri-point 255 toward base portion 231, and a second middle edge 254 may be positioned from second tri-point 256 toward base portion 231. Each of these edges may vary from being sharper to being more curved or rounded, and the side faces 239 and 243 may vary from being flat to curved or rounded. As shown in FIG. 2B, distal surface 261 of plunger 200 may have a hole 259 formed therein for receiving a stem from the slide assembly (see above). Cross-sectional diameter of distal surface 261 may be less than 1.5 inches, or about 1 inch or less, or from about 0.7 to about 0.8 inches. The edge(s) between the distal surface 261 of plunger 200 and the side surfaces or sides of base portion 231 (i.e., the side surfaces of base portion 231 facing internal surface of first opening 129 of spout) may also be rounded to encourage laminar fluid flow around these edges and to facilitate sliding of the plunger 200 through a first opening of spout. Like all other gradual surfaces within spout, this may also encourage a faster flow rate.

As described above, the tapering of the narrowing portion 233 may be favored to one side, such that it is closer to that side, which is preferably the top of the spout when assembled with the spout. The tapering of bottom surface 235 may be described as an angle relative to a line extending from the top side of base portion 231 of plunger 200 and/or relative to the top surface 257 of plunger 200, which in either case will be less than 90° and may be in a range from about 10° to about 50°, or alternatively from about 20° to about 40°, or about 30°. Such favored tapering of narrowing portion 233 to one side of plunger 200 may be described in terms of angles or lengths. The angle between bottom surface 235 and an imaginary line extending (proximally) from the bottom side of base portion 231 may generally be greater than the angle between top surface 257 and an imaginary line extending (proximally) from the top side of base portion 231. In terms of lengths or distances, such favored tapering to one side of plunger 200 may generally mean that bottom surface 235 is longer from base portion 231 to tip 234 than top surface 257.

As shown in FIG. 2C, top surface 257 of narrowing portion 233 of plunger 200 between base portion 231 and tip 234 may have a very slight tapered angle (β), which is also consistent with the tapering portion 231 and tip 234 being strongly angled or tapered off to one side. Relative to a line extending from the top side of base portion 231, top surface 257 of tapering portion 233 may have an angle of about 10° or less, or alternatively an angle of about 5° or less, or about 3° or less, or about 2° or less. This slight tapered angle (β) of the top surface 257 has at least a couple of advantages. First, the slight taper facilitates the sliding of the plunger 200 into a first opening 129 of a spout and its engagement with the inner surface of first opening and/or O-ring(s) disposed therein when the plunger 200 is moved from an open distal position to a closed proximal position. Another advantage relates to air flow. As discussed above, air flowing back into the container due to pouring and vacuum pressure travels along the upper portions of the spout interior. By tapering the top surface 257 of plunger 200, a slight spacing or slit of an opening may be created along the uppermost portion of first opening 129 of spout when the plunger 200 is moved distally to an open position. This allows air flowing from the upper portion of proximal cavity 157 of the spout back into the container to pass into the container without having to cross the flow of liquid or fuel in the lower portion of first opening 129 and proximal cavity 157. In this way, the plunger 200 may act as a separator between the distal flow of liquid/fuel into the spout and the proximal flow of air into the container. By minimizing the crossing of paths and interference with the liquid or fuel flow into the spout, a faster and more orderly flow rate may be achieved.

It is conceivable, however, that a plunger may be used according to some embodiments that functions more like a plug, especially in combination with other inventive features, which may have a base portion that corresponds to the first opening but an optional “tapering portion” that may be tapered at an angle anywhere from 0° to 90° (not shown). In other words, such a plunger or plug may vary between (i) a plunger or plug having a portion or segment that extends proximally from the base portion (i.e., past first opening when in a closed position) that has a constant cross-sectional area, and (ii) a plunger or plug having only a base portion with no “tapering portion” or extended portion at all. In either of these two extremes, the plunger may be a right cylinder if the first opening of the spout is circular. With such an embodiment, a bottom proximal portion or edge of the plunger may be cut-away or absent to function analogously to the narrowing portion described above.

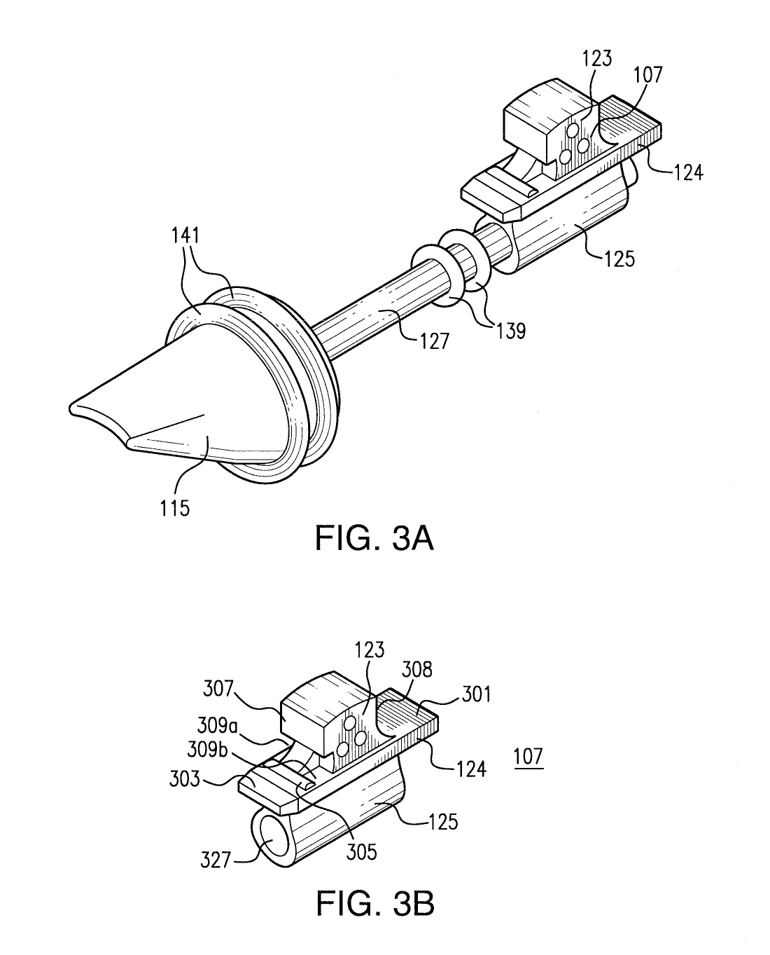

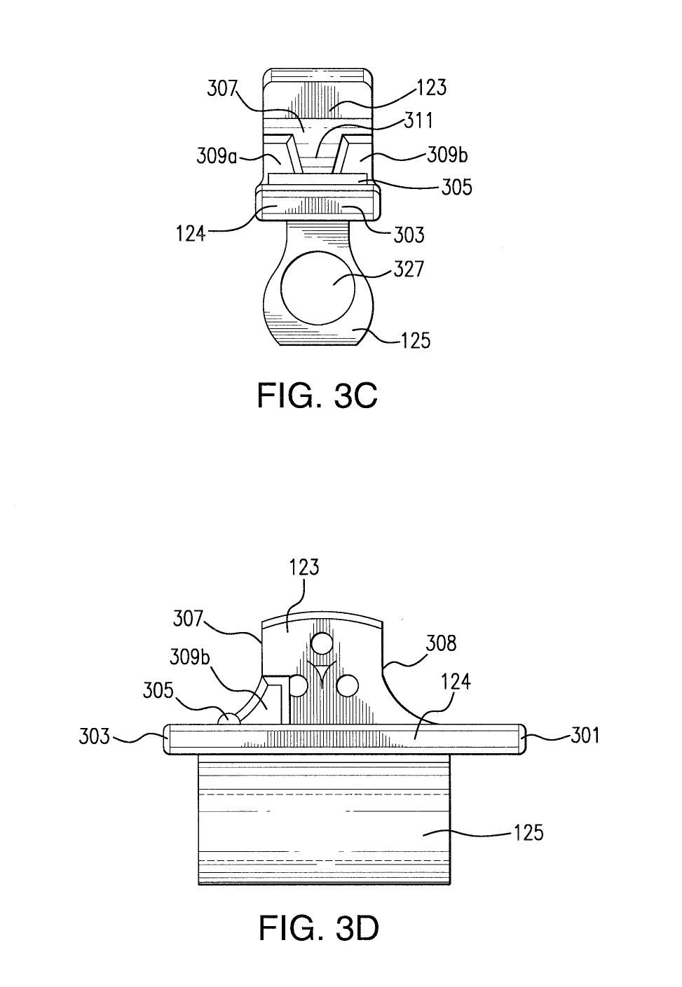

FIG. 3 shows the embodiment of a slide assembly from FIG. 1. FIG. 3A shows a perspective view of the slide assembly embodiment with the body of the spout removed for visualization. FIG. 3B shows a perspective view of only the slide 107 from FIG. 3A. As can be seen in FIGS. 3A and 3B, slide 107 is connected to plunger 115 by stem 127. Stem 127 is connected to lower portion 125 of slide 107. O-rings 139 and 141 are also shown. Upper portion 123 of slide 107 is used for direct manual operation, and middle portion 124 is between upper portion 123 and lower portion 125 of slide 107 to deliver force applied to upper portion 123 to lower portion 125. The total height of the slide 107 in the top-bottom direction may be about 0.8 to about 0.9 inches tall, of which the upper portion 123 may be about 0.3 to about 0.4 inches high, the middle portion 124 may be about 0.1 inches thick/high, and the lower portion 125 may be about 0.35 to about 0.4 inches high. The total width of the slide 107 in the side-side direction (i.e., perpendicular to the proximal-distal axis) may be about 0.3 to about 0.4 inches. Importantly for PFC applications, the maximum assembled width of the upper portion 123 of slide 107 and main body portion 103 may preferably be smaller than the opening of the PFC to allow the spout to be inserted up-side-down into the PFC for shipping and storage. Lower portion 125 of slide 107 may also have a bore 327 formed therein for receiving a stem linked to a plunger, which would be absent when the stem and slide are integrally formed.

In addition to FIG. 3B showing a perspective view of slide 107, FIGS. 3C and 3D show a proximal end view and a side view, respectively, of slide 107. As can be seen in these figures, middle portion 124 may also have distal extended portion 301 and proximal extended portion 303 lengthening middle portion 124 such that the plane of middle portion 124 is extended. By extending the length of middle portion 124 resting on ledge 155 in cavity 109 of spout 100, any rocking of slide 107 may be minimized when force is applied to slide 107 in either a proximal or distal direction. The lengths of distal extended portion 301 and proximal extended portion 303 may also define the range of motion of the slide assembly and slide 107 by their contact with the proximal and distal ends of cavity 109. For example, the distal extended portion 301 may be about 0.2 to about 0.25 inches long, and the proximal extended portion 303 may be about 0.1 inches long.

As introduced above, a locking mechanism may also be provided between a proximal portion of slide 107 and the proximal end of cavity 109. A locking mechanism is helpful to completely stop pouring during use and to ensure that the spout remains closed during storage. To utilize the locking mechanism, the user simply pulls the slide 107 connected to plunger 115 completely back until the slide locks into the closed position to block flow of liquid or fuel from the container. According to some embodiments, a type of snap-lock system may be used, which may involve a small tab(s) on a proximal portion of the slide 107 that is configured to interface and create an interference fit with a corresponding shape, such as a corresponding groove(s), of the cavity 109 at its proximal end. Such a snap-lock may be accompanied by an audible snap, which communicates to the user that the slide assembly is locked in the closed position. For example, a linear tab 305 may be upward facing and be disposed on the upper surface of middle portion 124 of slide 107 to engage a corresponding groove(s) formed in proximal end of cavity 109. Tab 305 may be disposed in a side-to-side line perpendicular to the proximal-distal axis of main body portion 103 of spout 100 on the proximal half of middle portion 124, such as at or near where upper portion 123 meets middle portion 124 of slide 107. One or more notches 309a, 309b may be present on either side of an intervening portion 311 on the proximal face 307 of upper portion 123 of slide 107. This may create room to allow two corresponding grooves (not shown) of cavity 109 to engage tab 305 on both sides of intervening portion 311. Such notches may be absent from distal face 308 of upper portion 123 of slide 107.

According to other aspects of the present invention, methods are provided for the assembly and operation of any embodiment of the spout device. In a first step, the proximal end of the spout may inserted into the opening of a container, and a cap may be used to secure the spout to the container. The container may be lifted, and the spout connected and secured to the container may be inserted into a machine, equipment, etc., to be filled with the liquid or fuel in the container. The container may be partially inverted to pour the liquid or fuel into the machine, equipment, etc. The slide assembly may be operated to first move the slide in a distal direction to open the spout to pour the contents of the container. During pouring, the flow rate may be adjusted in a continuously controlled manner by operating the slide assembly to achieve a desired flow rate. When a desired amount of liquid or fuel is poured, the slide may be slid or moved to a proximal position to close the spout, and the spout may be lifted out of the machine, equipment, etc., being filled without spilling.

While the present invention has been disclosed with reference to certain embodiments, it will be apparent that modifications and variations are possible without departing from the spirit and scope of the invention as defined in the appended claims. Furthermore, it should be appreciated that all examples in the present disclosure, while illustrating embodiments of the invention, are provided as non-limiting examples and are, therefore, not to be taken as limiting the various aspects so illustrated. For instance, while several dimensions, angles, etc., are provided as examples for spouts to be used with standard PFCs, such dimensions, angles, etc., of the spout of the present invention could vary considerably for other types of applications. The present invention is intended to have the full scope defined by the language of the following claims, and equivalents thereof. Accordingly, the drawings and detailed description are to be regarded as illustrative and not as restrictive.

What is claimed is:

1. A spout comprising:
an elongated body surrounding a continuous passageway within the body, the passageway extending from a first opening at the proximal end of the body to an exit opening at or near the distal end of the body, wherein the spout has a top and a bottom;
a slide assembly comprising a slide and a plunger, wherein the slide is physically coupled to the plunger such that movement of the slide causes tandem movement of the plunger, wherein the slide is positioned distally to the plunger,
wherein the plunger has a base portion and a narrowing portion, the narrowing portion tapering from the base portion to a plunger tip, the base portion of the plunger being wider than the plunger tip, wherein the narrowing portion of the plunger is oriented proximally to the base portion of the plunger,
wherein distal movement of the slide causes movement of the base portion of the plunger out of or away from the first opening, and wherein proximal movement of the slide causes movement of the base portion of the plunger into or toward the first opening, and
wherein the cross-sectional size and shape of the base portion of the plunger is about the same as the cross-sectional size and shape of the first opening such that the plunger closes the first opening when at least part of the base portion is inserted into the first opening.

2. The spout of claim 1, wherein the body of the spout comprises a main body portion and a nozzle portion, wherein the nozzle portion is positioned distally to the main body portion and is angled downward relative to the main body portion.

3. The spout of claim 2, wherein the exit opening is disposed in a bottom-distal location of the nozzle portion of the spout.

4. The spout of claim 2, wherein the angle between the longitudinal axis of the main body portion and the longitudinal axis of the nozzle portion is in a range from about 20° to about 40°.

5. The spout of claim 1, wherein the slide is positioned on the top of the spout.

6. The spout of claim 1, wherein the narrowing portion of the plunger has a top surface and a bottom surface, and wherein the tapering of the narrowing portion of the plunger is strongly favored to one side of the plunger such that the length of the bottom surface of the narrowing portion of the plunger from the base portion to the plunger tip is greater than the length of the top surface of the narrowing portion of the plunger from the base portion to the plunger tip.

7. The spout of claim 6, wherein the top surface of the plunger is oriented toward the top of the body of the spout.

8. The spout of claim 1, wherein the slide is coupled to the plunger by a stem, wherein the proximal end of the stem is connected to the plunger and the distal end of the stem is connected to the slide.

9. The spout of claim 1, wherein the movement of the slide is generally confined to a proximal-distal axis by a cavity disposed and recessed within the body of the spout.

10. The spout of claim 9, wherein the cavity comprises a lower slot and a ledge, wherein the slide comprises an upper portion, a middle portion, and a lower portion, wherein the lower portion of the slide is positioned within the lower slot of the cavity such that the lower slot confines the movement of the slide to the proximal-distal axis, and wherein the middle portion of the slide rests on the ledge.

11. The spout of claim 9, wherein the cavity is separated from the passageway within the body of the spout by a plurality of walls, wherein the plurality of walls include a proximal wall, a distal wall, a first side wall, a second side wall and a bottom wall.

12. The spout of claim 11, wherein the continuous passageway comprises a proximal chamber, a central passage and a nozzle lumen,
wherein the proximal chamber and the central passage correspond to the portion of the passageway within a main body portion of the spout, wherein the central passage corresponds to the portion of the passageway between the plurality of walls and the outer sides of the main body portion, wherein the central passage is distal to the proximal chamber, and wherein the nozzle lumen corresponds to the portion of the passageway within a nozzle portion of the spout, and
wherein the nozzle portion is positioned distally to the main body portion, and wherein the nozzle portion is angled downward relative to the main body portion.

13. The spout of claim 12, wherein the proximal chamber is disposed between the proximal wall of the cavity and the first opening of the body of the spout, wherein the central passage is disposed between the outer sides of the body of the spout and the first side wall, second side wall and bottom wall of the cavity of the spout.

14. The spout of claim 11, wherein the slide is coupled to the plunger by a stem, wherein the proximal end of the stem is connected to the plunger and the distal end of the stem is connected to the slide, and wherein the stem passes through a bore in the proximal wall of the cavity.

15. The spout of claim 11, wherein the central passage is U-shaped in a cross-sectional plane perpendicular to the proximal-distal axis, the central passage having a lower channel between bottom side of spout and the bottom wall of cavity, a first side channel between a first outer side of the spout and the first side wall of the cavity, and a second side channel between a second outer side of the spout and the second side wall of the cavity.

16. The spout of claim 15, wherein the body of the spout comprises a main body portion and a nozzle portion, wherein the nozzle portion is positioned distally to the main body portion, and
wherein the nozzle portion is angled downward relative to the main body portion,
wherein the passageway includes a nozzle lumen inside the nozzle portion, and wherein the distal wall of the cavity tapers in a distal direction to a point fused with a top side of the nozzle portion of the spout.

17. The spout of claim 16, wherein the nozzle lumen has a cone shape with the proximal portion of the nozzle lumen being wider than the distal portion of the nozzle lumen.

18. A spout comprising:
an elongated body surrounding a continuous passageway within the body, the passageway extending from a first opening at the proximal end of the body to an exit opening at or near the distal end of the body, wherein the spout has a top and a bottom;
a slide assembly comprising a slide, a stem and a plunger, wherein the slide is physically coupled to the plunger by the stem such that movement of the slide causes tandem movement of the plunger, wherein the proximal end of the stem is connected to the plunger and the distal end of the stem is connected to the slide, and wherein the slide is positioned distally to the plunger;
wherein the movement of the slide is generally confined to a proximal-distal axis by a cavity disposed and recessed within the body of the spout,
wherein a base portion of the plunger has a cross-sectional size and shape in a plane perpendicular to the proximal-distal axis that is about the same as the cross-sectional size and shape of the first opening,
wherein distal movement of the slide causes movement of the base portion of the plunger out of or away from the first opening, and wherein proximal movement of the slide causes movement of the base portion of the plunger into or toward the first opening.

19. The spout of claim 18, wherein the cavity is separated from the passageway within the body of the spout by a plurality of walls, wherein the plurality of walls include a proximal wall, a distal wall, a first side wall, a second side wall and a bottom wall, and wherein the stem passes through a bore in the proximal wall of the cavity.

20. The spout of claim 18, further comprising a locking mechanism at or near the proximal end of the cavity, wherein the locking mechanism causes the slide assembly to become reversibly locked in a closed position when the slide is moved fully in the proximal direction.

21. The spout of claim 18, wherein the plunger has a right cylinder shape.

22. A spout comprising:
an elongated body surrounding a continuous passageway within the body, the passageway extending from a first opening at the proximal end of the body to an exit opening at or near the distal end of the body, wherein the spout has a top and a bottom;
a slide assembly comprising a slide and a plunger, the slide being disposed in a cavity, the cavity being recessed within the body of the spout, wherein the slide is physically coupled to the plunger such that movement of the slide causes tandem movement of the plunger,
wherein the slide is positioned distally to the plunger, wherein distal movement of the slide causes movement of the plunger out of or away from the first opening, and wherein proximal movement of the slide causes movement of the plunger into or toward the first opening,
wherein the body of the spout comprises a main body portion and a nozzle portion, wherein the nozzle portion is positioned distally to the main body portion and is angled downward relative to the main body portion, and
wherein the passageway includes a nozzle lumen inside the nozzle portion of the body, wherein the nozzle lumen has a cone shape with the proximal portion of the nozzle lumen being wider than the distal portion of the nozzle lumen.

23. The spout of claim 22, wherein the exit opening is disposed in a bottom-distal location of the nozzle portion of the spout.

24. The spout of claim 23, wherein a plane defined by the edges of the exit opening is configured at a non-perpendicular angle relative to a distal outer face of the nozzle portion.

25. The spout of claim 22, wherein the cavity is separated from the passageway by a plurality of walls, wherein the plurality of walls include a proximal wall, a distal wall, a first side wall, a second side wall and a bottom wall, and wherein the distal wall of the cavity tapers in a distal direction to a point fused with a top side of the nozzle portion of the spout.
